(19) United States
(12) Patent Application Publication
(10) Pub. No.: US 2011/0098965 A1
(43) Pub. Date: Apr. 28, 2011

(54) TEMPERATURE DETECTION DEVICE

(76) Inventors: Yin Nang CHAN, Hong Kong (HK); Hing Kwai CHAU, Hong Kong (HK); Wing Biu CHEUNG, Hong Kong (HK); Chi Leung CHEUNG, Hong Kong (HK)

(21) Appl. No.: 12/651,682

(22) Filed: Jan. 4, 2010

(30) Foreign Application Priority Data
Oct. 23, 2009 (HK) 200920206335.3

(51) Int. Cl. G01K 13/00; G06F 15/00

(52) U.S. Cl. 702/130; 374/150; 374/E13.001

(57) ABSTRACT

A temperature detection device includes a bottle having a temperature sensor for detecting the temperature of a fluid within the bottle, and a station able to receive the bottle. The temperature sensor can be connected via electrical contacts by putting the bottle onto the station. The station includes a display device and power supply. The contacts on the station are mounted on a vertically movable biasing element, the contacts on the station can be moved from a first position in which the contacts are electrical isolated into a second position, wherein the contacts are connecting a calculation unit, the display device and the power supply. Preferably, the temperature detection device can be switched into operating mode by putting the filled bottle into the station. This connects the relevant units for measuring, calculating and displaying the temperature. The milk bottle can be separated from the thermistor and can be washed easily.

The invention relates to a temperature detection device comprising a bottle having a temperature sensor for detecting the temperature of a fluid within the bottle.

### BACKGROUND OF INVENTION

In particular for feeding babies from a bottle it is desirable to know the temperature of the liquid in the bottle. Previous efforts to meet this have disclosed feeding bottles for babies, where the temperature of the liquid leads to a change in the colour of the wall defining a hollow interior. For example US 2002/0030030 A1 discloses a bottle made of a material which undergoes a change in colour, when the temperature reaches a predetermined value.

Currently on the market, there are some similar bottle products which also have a temperature display to show the temperature of the liquid in the bottle but however, the existing temperature display bottles already on the market have the following disadvantages:

1. The bottle cannot be separated from its electronic thermistor and is therefore very inconvenient or difficult to wash and clean.

2. The metal temperature probe connection is not reliable because of the way that the lid is mounted by insert moulding and the fact that there is a plastic/rubber covering on the temperature detector device, thus creating an inaccurate reading.

3. The electrical wires or temperature conducting wires are exposed outside the bottles which can be both dangerous to the user and the baby and is very unsightly and can be accidentally broken.

### OBJECT OF THE INVENTION

Taking into consideration the drawbacks of the current temperature detection of feeding bottles currently available in the market, it is necessary to improve and develop a much more precise and user friendly product for the consumer to use, or at least to provide the public with a useful choice.

### SUMMARY OF INVENTION

According to one aspect the invention consists in a temperature detection device comprises a bottle having a temperature sensor for detecting the temperature of a fluid within the bottle, a station able to receive the bottle in use, wherein the temperature sensor can be connected via electrical contacts by putting the bottle onto the station. The station includes a display device and a power supply. According to the invention the contacts on the station are mounted on a vertically movable biasing means, the contacts on the station can be moved from a first position in which the contacts are electrical isolated into a second position, wherein the contacts are connecting a calculation unit, the display device and the power supply. Preferably in use the temperature detection device can be switched into an operating mode by putting the filled bottle into the station. This will connect the relevant units for measuring, calculating and displaying the temperature. The milk bottle can be separated from the thermistor and can be washed easily.

It is of advantage if the vertically movable biasing means is spring-mounted. Therefore the vertically movable biasing means returns into the first position for an electric isolation of the contacts if there is no weight on it from the bottle. The switching into an operating modus is therefore dependent from the weight put on the vertically movable biasing means. This leads to the advantage that the empty bottle can be kept in the station without switching the device in the operating modus.

In other aspects herein described, the vertically movable biasing means have at least one spring-mounted contact for connecting the calculation unit to the power supply and the temperature sensor. This contact is permanently connected to the calculation unit for supply voltage of the calculation unit. By pushing the vertically movable biasing means this contact will be connected to the power supply and to one of the contact elements getting connected to the bottle. This contact element is permanently connected to the calculation unit for the measurement. This easily switches the device into an operating modus by pushing down the vertically movable biasing while putting the bottle into the station.

In an advantageous embodiment the vertically movable spring base has at least one spring-mounted contact device, showing spatial fixed electrical isolated contact elements. By putting the bottle into the station the contacts of the bottle engage or meet with this contact device. Therefore this contact arrangement needs to be spatial similar and is preferably rotationally symmetric. Both contact elements are permanently connected to the calculation unit transmitting the measurement signal.

Preferably, the temperature probe is a thermal element, in particular a thermistor. Since the metal probe is made of stainless steel, it is more accurate than using a plastic coated metal temperature probe.

Another preferred solution has mounted the calculation unit on a circuit board. In particular for the production this allows to assemble the calculation unit by connecting the circuit before building it into the station.

It is advantageous if the temperature sensor is welded into the bottom of the bottle. The metal part of the bottle which is used to detect the temperature of the liquid are implemented by injection-insert moulding and therefore will not leak. One of the most significant features of this patent product is that all the electronic and metal parts are devised to be contained neatly into the bottom cover of the bottle, giving the user more convenience to separate the parts and it is very simple to use and has not got unsightly wires showing.

Preferably the display device includes a light for day and night use.

### BRIEF DESCRIPTION

The invention will now be described, by way of example only, by reference to the accompanying drawings:

FIG. 1 is the configuration of the bottle and station including a LCD display in accordance with a preferred embodiment of the invention.

FIG. 2 is a configuration of the temperature probe in accordance with a preferred embodiment of the invention.

FIG. 3 is a configuration of the station using a first and a second contact mounted on the vertically movable biasing means in accordance with a preferred embodiment of the invention.

FIG. 4 is the configuration of the station from FIG. 3 from another aspect ratio when the bottle is received in accordance with a preferred embodiment of the invention.

FIG. 5 is a configuration of the station showing vertically movable biasing means in accordance with a preferred embodiment of the invention.

FIG. 6 is a circuit diagram for a processor of a calculation unit in accordance with a preferred embodiment of the invention.

### DESCRIPTION OF DRAWINGS

The following will describe the invention in relation to preferred embodiments thereof, namely a temperature detection device comprising a bottle having a temperature sensor for detecting the temperature of a fluid within the bottle. The invention is in no way limited to these preferred embodiments as they are purely to exemplify the invention only and that possible variations and modifications would be readily apparent without departing from the scope of the invention.

FIG. 1 shows the configuration of a bottle 1 such a babies milk bottle. The bottle 1 is covered by a cap to receive the bottle 1. A station 2 is formed at the upper side to receive the bottle 1 in use. The station 2 includes a display device 3 such as a Liquid Cristal Display (LCD), on which the temperature measured can be seen by a user. The feeding bottle 1 has a thermistor in its bottom which is electrically connected to the contacts mounted on the vertically movable biasing means at the station 2 (see FIG. 3) by putting the bottle 1 onto the station 2. The LCD 3 is mounted into the sidewall of the station 2, to show the liquid temperature of the bottle 1.

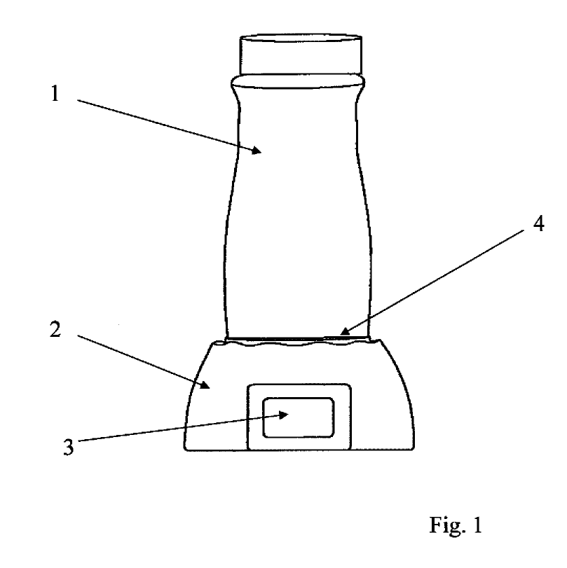

FIG. 2 shows a screw cap bottom-element 4 of a bottle 1. The screw cap bottom-element 4 comprises a temperature probe 5 located on its upper side. The temperature probe 5 is advantageously moulded into the screw cap bottom-element 4. Typically but not necessarily such temperature probes 5 can be diodes, wherein the current is dependent on the temperature. By applying a sheeted voltage a constant low current will be created. Using the voltage difference a thermal coefficient can be used to calculate the temperature. An electrical connection between the temperature probe 5 and the station (see FIG. 3) is made by metal contacts 6 underneath the bottom of the bottle 1.

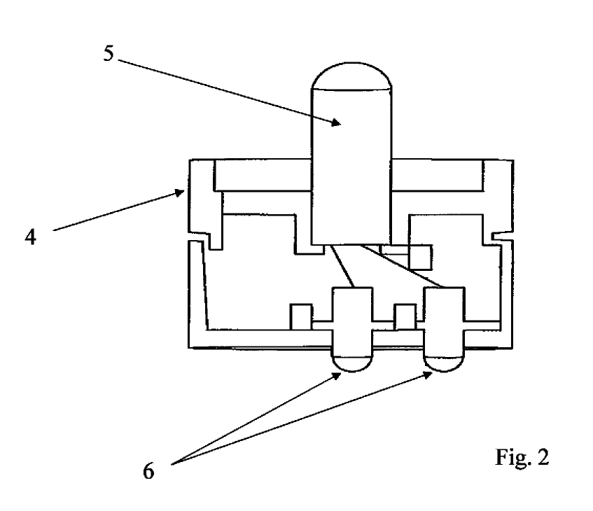

FIG. 3 shows a configuration of the station 2. The station 2 has a housing 7 includes a power supply 17 (typically a battery), a display and a calculation unit 12 mounted on a circuit board 8. The housing 7 has a recess 13 for receiving the bottle 1. The vertically movable biasing means 14 located at the bottom of the recess 13 is mounted on a spring 11 which presses the vertically movable biasing means 14 against a stop member 16 of the housing 7 in that way that vertically movable biasing means 14 will be at least partly above the bottom of the recess 13. The vertically movable biasing means 14 includes a contact device comprising spring loaded contact element 9 and a fixed contact element 10 for electric connection to the bottle 1. The contact elements 9, 10 constitute in certain areas the surface of the vertically movable biasing means 14. The vertically movable biasing means 14 includes a spring mounted contact 11 formed as pin. This spring mounted contact 11 can be connected at its distal ends to a power supply contact area 15 and the fixed contact element 10 by pressing down the vertically movable biasing means 14. This arrangement connects by pushing down the vertically movable biasing means 14 the spring mounted contact 11 to the power supply contact area 15 and to the fixed contact element 10. In this operating state the contact element 10 is electrically connected to the metal contacts 6 of the bottle 1 and the calculation unit 12 to conduct a measurement of the temperature probe 5. The actuation of the vertically movable biasing means 14 switches also the LCD 3, for displaying the temperature.

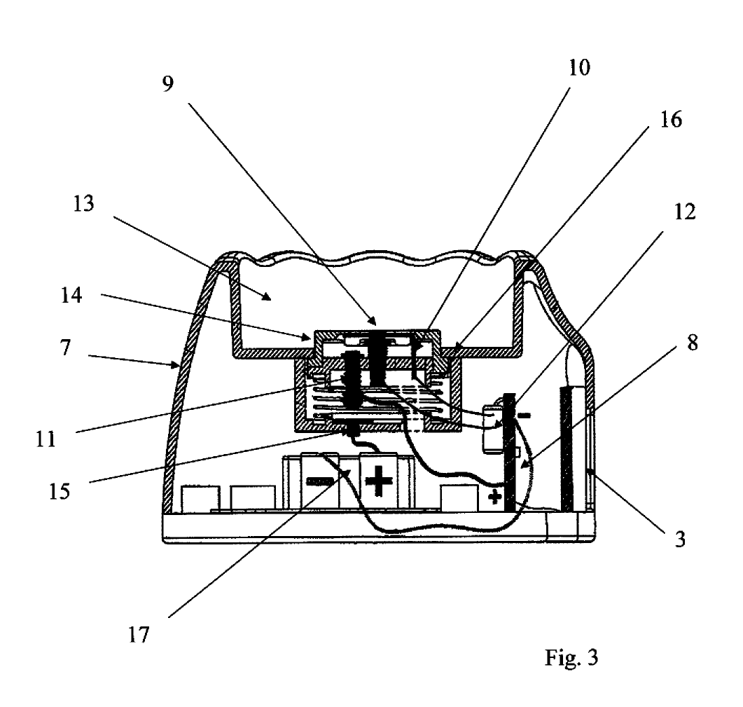

FIG. 4 shows the configuration of the station from FIG. 3 from another aspect and when the bottle is received. The housing 7 of the station has a recess 13 for receiving the screw cap bottom-element 4 of a bottle 1. A thermal probe 5 is moulded into the screw cap bottom-element 4 of the bottle. The thermal probe 5 is connected by metal contacts 6 to the contact device of the station in that way that the centre contact rests on the spring contact element 9 and the outer one on the fixed contact element 10. The vertically movable biasing means 14 located at the bottom of the recess 13 is mounted on a spring 11 which presses the vertically movable biasing means 14 against the screw cap bottom-element 4. From this aspect the fixed contact element shows a bent region 10 for wiring to the calculation unit 12.

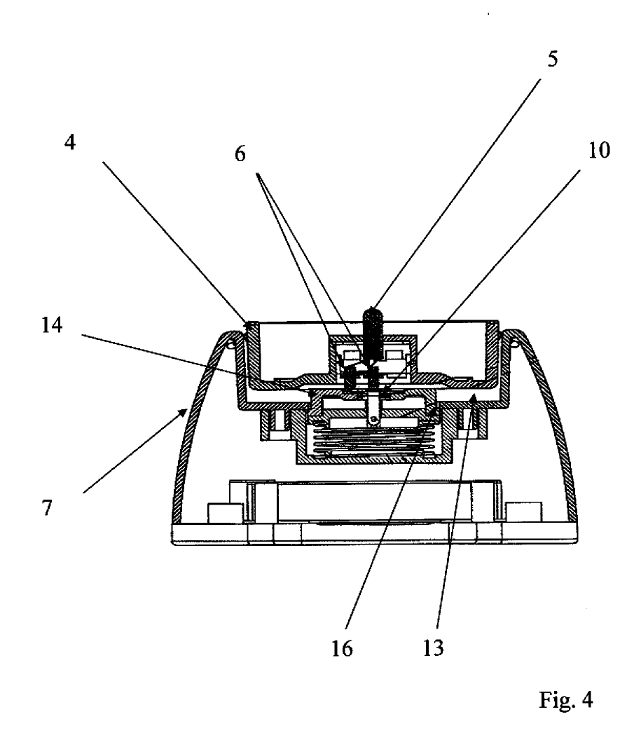

FIG. 5 shows the configuration of the station 2. The station 2 has a recess 13 in which a bottle in use can be received. The station 2 includes a display device 3. The vertically movable biasing means 14 are mounted onto the station 2 to avoid a rotation of the vertically movable biasing means 14 by two stop ends 17 which are formed to mesh into equivalent slots in the upper surface of the station 2.

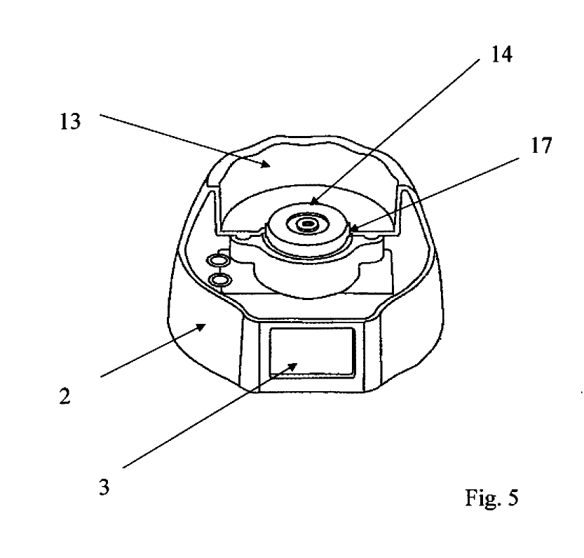

FIG. 6 shows a circuit diagram for connecting a calculation unit including a processor. This invention is in now way restricted to a specific amount of processors or the shown type. For a better orientation several areas have been drawn. Within the area referring to the temperature probe 5 a power switch (pin 38), a switch for the physical units Fahrenheit and Celsius (pin 39), and for the adjustment referring to the measuring range (pin 40) can be seen. The adjacent area relates to the power supply 7. The display unit 3 formed by an LCD is controlled due the pins on the right hand side (pins 10 to 27). An optional section 18 could be used for controlling an audio signal.

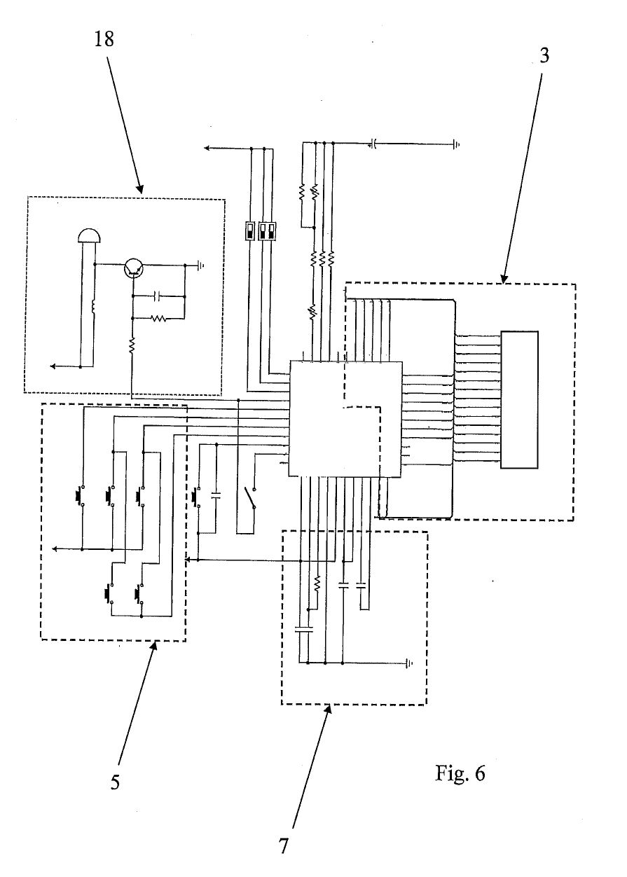

### ADVANTAGES

The new practical temperature measurement device, is used for temperature indication of hot liquids in a bottle and allows users to easily read the liquid temperature via a LCD to determine whether the liquid is hot enough for baby's/infant consumption. The electronic module of the station can be separated from the bottle when it needs to be cleaned. Hence it's practicality and convenience and will benefit users who desire a product that is both useful and easy to use.

### VARIATIONS

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

This temperature detection device is a much needed item in today's infant product market. The concept of this feeding bottle means that at every feed, the right temperature can be monitored. Therefore the device can detect the temperature of liquids inside an especially designed infant feeding bottle. The device has a bottle and a station, wherein the bottle has a main body and a bottom cover. The station serves as stand for the bottle and includes a LCD. The bottom cover of the bottle of the device has a temperature metal probe conducted with metal contacts. Once that connection has been made, a reading of the temperature of the liquid inside the bottle will appear on the LCD.

1. A temperature detection device comprising a bottle having a temperature sensor for detecting the temperature of a fluid within the bottle, a station able to receive the bottle in use, wherein the temperature sensor can be connected via electrical contacts by putting the bottle onto the station, and wherein the station includes a display device and a power supply, characterized in that the contacts on the station are mounted on a vertically movable biasing means, the contacts at the station can be moved from a first position in which the contacts are electrical isolated into a second position, wherein the contacts are connecting a calculation unit, the display device and the power supply.

2. A temperature detection device according claim 1 wherein the vertically movable biasing means is spring-mounted.

3. A temperature detection device according claim 1 wherein the vertically movable biasing means has at least one spring-mounted contact for connecting the calculation unit to the power supply and the temperature sensor.

4. A temperature detection device according to claim 1 wherein the vertically movable biasing means has at least one spring-mounted contact device, showing spatial fixed, electrical isolated contact elements.

5. A temperature detection device according to claim 1 wherein the temperature sensor is a thermal element, in particular a thermistor.

6. A temperature detection device according to claim 1 wherein the calculation unit is a microprocessor.

7. A temperature detection device according to claim 1 wherein the microprocessor is mounted on a circuit board.

8. A temperature detection device according to claim 1 wherein the temperature sensor is welded into the bottom of the bottle.

9. A temperature detection device according to claim 1 wherein the display device includes a light.

10. A temperature detection device according claim 2 wherein the vertically movable biasing means has at least one spring-mounted contact for connecting the calculation unit to the power supply and the temperature sensor.

11. A temperature detection device according to claim 2 wherein the vertically movable biasing means has at least one spring-mounted contact device, showing spatial fixed, electrical isolated contact elements.

12. A temperature detection device according to claim 3 wherein the vertically movable biasing means has at least one spring-mounted contact device, showing spatial fixed, electrical isolated contact elements.

13. A temperature detection device according to claim 2 wherein the temperature sensor is a thermal element, in particular a thermistor.

14. A temperature detection device according to claim 3 wherein the temperature sensor is a thermal element, in particular a thermistor.

15. A temperature detection device according to claim 4 wherein the temperature sensor is a thermal element, in particular a thermistor.

16. A temperature detection device according to claim 2 wherein the calculation unit is a microprocessor.

17. A temperature detection device according to claim 3 wherein the calculation unit is a microprocessor.

18. A temperature detection device according to claim 4 wherein the calculation unit is a microprocessor.

19. A temperature detection device according to claim 5 wherein the calculation unit is a microprocessor.

20. A temperature detection device according to claim 2 wherein the microprocessor is mounted on a circuit board.
